(19) United States
(12) Patent Application Publication
(10) Pub. No.: US 2024/0175501 A1
(43) Pub. Date: May 30, 2024

(54) Hydraulic Control Slider with Integral Anti-Rotation Lock, Hydraulic Valve, and Manufacturing Process

(71) Applicant: Robert Bosch GmbH, Stuttgart (DE)

(72) Inventors: Dominik Ebert, Hammelburg (DE); Andreas Mehling, Hafenlohr (DE); Andreas Endres, Steinfeld (DE); Karsten Dittrich, Wuerzburg (DE)

(21) Appl. No.: 18/515,520

(22) Filed: Nov. 21, 2023

(30) Foreign Application Priority Data
Nov. 28, 2022 (DE) 10 2022 212 663.7

(51) Int. Cl. F16K 11/07

(52) U.S. Cl. CPC F16K 11/0704

(57) ABSTRACT

A hydraulic control slider is arranged longitudinally displaceably in a housing bore of a hydraulic valve. The control slider includes a middle portion having a number of control edges, and two end portions each arranged on either side of the middle portion. One end portion of the two end portions includes a radially outwardly protruding control slider integral lug.

This application claims priority under 35 U.S.C. § 119 to patent application no. DE 10 2022 212 663.7, filed on Nov. 28, 2022 in Germany, the disclosure of which is incorporated herein by reference in its entirety.

The present disclosure relates to a hydraulic control slider with integral anti-rotation lock, a hydraulic valve with the hydraulic control slider, and a manufacturing process for the hydraulic control slider.

### BACKGROUND

Conventional hydraulic valves have a valve housing or a valve block in which a control slider is longitudinally displaceable in a housing bore. The control slider is thereby movable or switchable by a force generated from an actuator, for example a magnetic force resulting from the pairing of a solenoid coil and a pole tube. The control slider comprises a number of control edges arranged next to one another along a longitudinal axis of the control slider. The control edges are moved by the longitudinal movement of the control slider and thereby release or cover valve ports in the valve housing. Thus, the hydraulic valve can be moved or switched between different switch positions.

As a rotation of the control slider about the longitudinal axis relative to the valve housing is undesirable, the control slider has an anti-rotation lock. In known hydraulic valves, a tensioning pin is pressed into a bore at an end portion of the control slider prior to assembly of the control slider. This tensioning pin is guided in a guide sleeve or a guide groove in the pole tube, and thereby prevents unwanted rotation of the control slider.

The length of the guide groove is determined by the maximum possible axial travel distance of the control slider in the housing bore.

The use of the pressed-in tensioning pin has a number of drawbacks. On the one hand, pressing the tensioning pin into the bore of the control slider requires a separate assembly step. Furthermore, the tensioning pin must be aligned in the direction of the groove contact surface when pressing in to minimize wear or abrasion in the groove. If the tensioning pin is pressed in incorrectly, it must be removed again and a new tensioning pin fitted. Long-term trials have further shown that the combination of the guide groove and the tensioning pin is subject to heavy wear or can be destroyed under sufficiently high loads.

Therefore, the object of the present disclosure is to overcome or minimize the disadvantages of the prior art and, in particular, to provide a hydraulic control slider that is effectively protected against rotation about its longitudinal axis, while at the same time minimizing assembly work and increasing the service life of the control slider.

### SUMMARY

This task is achieved by a hydraulic control slider according to the features disclosed herein. The object of the disclosure is further achieved by a hydraulic valve and a manufacturing process as disclosed herein.

The present disclosure relates to a hydraulic control slider arranged to be longitudinally displaceable or movable in a housing bore of a hydraulic valve. The control slider comprises a middle portion having a number of control edges and two end portions arranged on each side of the middle portion. According to the disclosure, one of the end portions has a radially outwardly protruding control slider integral lug. The control slider integral lug can preferably be accommodated as an anti-rotation lock in a guide groove of a pole tube.

In this context, control slider integral means that the lug is an (integral) part of the control slider. In particular, control slider integral means that the lug and the control slider are manufactured in the same manufacturing step, and that the lug is not mounted on the control slider subsequently or in a separate manufacturing or assembly step. The lug is in particular made of the same material as the control slider. Therefore, the lug is a common component like the control slider.

In a housing bore of a hydraulic valve or a switching valve, the control slider is movably mounted along the longitudinal axis. The pole tube is preferably screwed into the housing bore of the valve housing. The control slider has a slide piston extending along the longitudinal axis. The number of control edges arranged next to each other in the longitudinal direction of the slide piston protrude from the slide piston in the radial direction. The slide piston has two end portions, each extending next to the control edges.

The lug protrudes radially from the cross-section or diameter of the slide piston. That is to say, the lug protrudes from the basic shape of the slide piston in the radial direction.

The control slider according to the disclosure has the following advantages. The lug has the function of an anti-rotation lock, which prevents unwanted rotation of the control slider relative to the control cylinder. The component-integral design of the lug eliminates the need for an assembly step. This saves on purchasing and assembly costs. The design of the lug as an integral part of the slide piston ensures that the lug is particularly resistant to wear. Thus, the load resistance of the control slider is increased or the failure probability is reduced.

The object of the disclosure is further solved by a hydraulic valve. The hydraulic valve has a valve housing and a control slider which is movably mounted in the housing bore of the valve housing. The control slider comprises an anti-rotation lock that protrudes radially outward from the control slider, and is accommodated in a guide groove of a pole tube, which is mounted in the housing bore of the valve housing, and that prevents a rotation of the control slider about the longitudinal axis relative to the valve housing and/or housing bore. The anti-rotation lock is designed as the control slider integral lug.

The hydraulic valve with the control slider integral lug has in particular a high resistance to wear on the contact surface between the guide groove and the control slider integral lug. Furthermore, the design of the lug as an integral part of the control slider can save a manufacturing step.

The present disclosure further relates to a manufacturing process for a control slider according to the above aspects. The manufacturing process comprises the following steps: Firstly, the control slider is machined, in particular milled, from a raw material. In this step, the lug of the control slider in particular is machined, in particular milled, as an integral part of the control slider. In a further step, the machined control slider is heat-treated, in particular hardened.

It is of course conceivable that the step of machining can also involve turning the control slider.

The method of manufacturing process according to the disclosure can save one assembly step, namely the pressing in of the separate tensioning pin. This saves time and cost. Furthermore, a high (surface) hardness of the material can be achieved by heat treating the control slider. This can in particular increase the wear resistance.

According to an optional advantageous aspect of the present disclosure, the control slider integral lug may be spaced apart from an end edge of the control slider. Preferably, the lug is spaced 1 mm from the end edge. This may ensure that the control slider integral lug does not unthread from the guide groove when the hydraulic valve is switched, i.e., when the control slider is displaced.

Preferably, the control slider integral lug may extend in the longitudinal direction

of the control slider.

According to another optional aspect of the present disclosure, the control slider integral lug may be between 2 mm and 6 mm in length, particularly preferably 4 mm. The elongated extension of the control slider integral lug prevents unthreading from the guide groove.

Preferably, the control slider integral lug may be between 1 mm and 3 mm wide, particularly preferably 2 mm. The width of the control slider integral lug may be substantially adapted to the width of the guide groove.

According to another optional aspect of the present disclosure, the control slider integral lug may protrude radially from the end portion between 1 mm and 3 mm, particularly preferably 1.7 mm.

Preferably, the step of heat treating the control slider may include or be induction hardening. In particular, only the control edges can be hardened. Induction hardening can achieve a high accuracy and low material distortion due to the precisely targeted hardening of only a predetermined area. That is to say, the location requiring a high surface hardness can be precisely hardened without the rest of the component distorting due to the heat input. In particular, embrittlement of the portions of the component where toughness or easy deformability is advantageous can be prevented by precise induction hardening.

According to a further optional feature of the present disclosure, the step of heat treating the control slider may include or comprise oven hardening. Oven hardening heats the entire control slider evenly. This minimizes possible stress formation in the component. Oven hardening also hardens the complete surface of the control slider, thus increasing the surface hardness. This reduces wear when switching the hydraulic valve.

Oven hardening may further be characterized by short lead times of the individual components and advantageous handling of the components. The machining cost per piece can be kept low during oven hardening.

Preferably, the step of heat treating the control slider may comprise carbonitriding. This may increase the surface hardness of the control slider.

According to another optional feature of the present disclosure, the step of machining the control slider can be divided into two steps. First, a control slider blank may be turned from the raw material. The control slider blank may be oversized, particularly in the area of the end portions. In the next step, the control slider with the integral lug can be milled from the control slider blank with the oversize. The contour or shape of the control edges can also be milled. Due the machining process, the control slider can be manufactured inexpensively and precisely.

### BRIEF DESCRIPTION OF THE DRAWINGS

FIG. 1 shows a longitudinal section through a hydraulic valve according to the prior art;

FIG. 2 shows a perspective view of a hydraulic control slider according to the prior art with a separate tensioning pin;

FIG. 3 shows an excerpt of a longitudinal section through a hydraulic valve according to the present disclosure;

FIG. 4 is a perspective view of a control slider according to the present disclosure;

FIG. 5 is a perspective view of an end portion of the control slider according to the present disclosure; and

FIG. 6 shows a flowchart of a manufacturing process according to the present disclosure.

### DETAILED DESCRIPTION

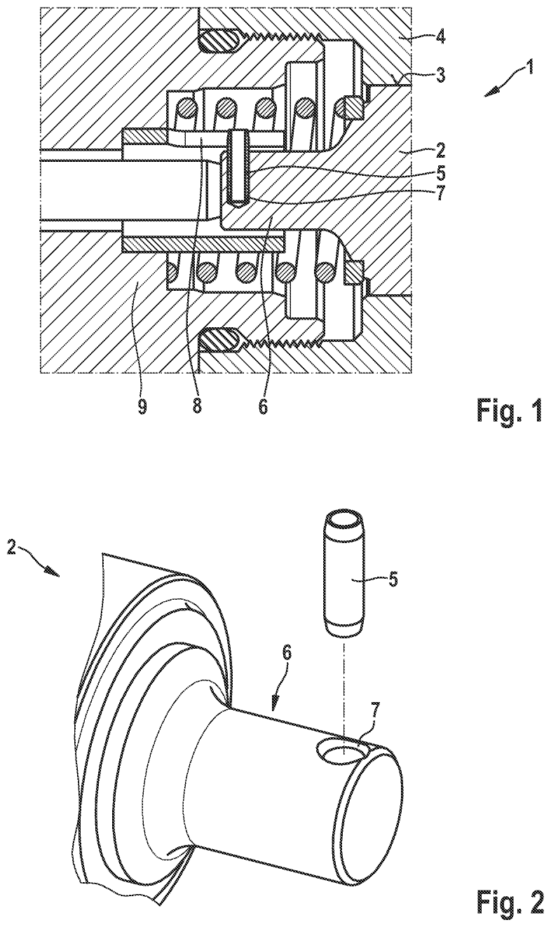

FIG. 1 shows a longitudinal section through a hydraulic valve 1 according to the prior art. A hydraulic control slider 2 is movably arranged in a housing bore 3 of a valve housing or valve block 4 of the hydraulic valve 1. The control slider 2 comprises a tensioning pin 5, which is pressed into an end portion 6 of the control slider 2 in a bore 7 in the end portion 6, and which protrudes radially from the cross-section of the end portion 6. The tensioning pin 5 is accommodated in a guide groove or guide sleeve 8 of a pole tube 9, and is axially guided, such that it is mounted in the valve housing 4 or the housing bore 3. The combination of the tensioning pin 5 and the guide groove 8 results in an anti-rotation lock that prevents unwanted rotation of the control slider 2 relative to the housing bore 3. The exemplary hydraulic valve 1 is biased by a spring.

FIG. 2 shows the end portion 6 according to the prior art. The end area of the control slider comprises the bore 7, into which the tensioning pin 5 is pressed. The pressing of the tensioning pin 5 into the bore 7 is carried out in a separate assembly step. The design of the anti-rotation lock as the pressed-in tensioning pin 5 thus has the following disadvantages. The pressing-in of the tensioning pin 5 is an additional manufacturing or assembly step. Due to the small size of the tensioning pin 5, the tensioning pin 5 can be pressed in incorrectly. Furthermore, the contact surface between the tensioning pin 5 and the guide groove 8 is susceptible to wear when the hydraulic valve 1 is switched.

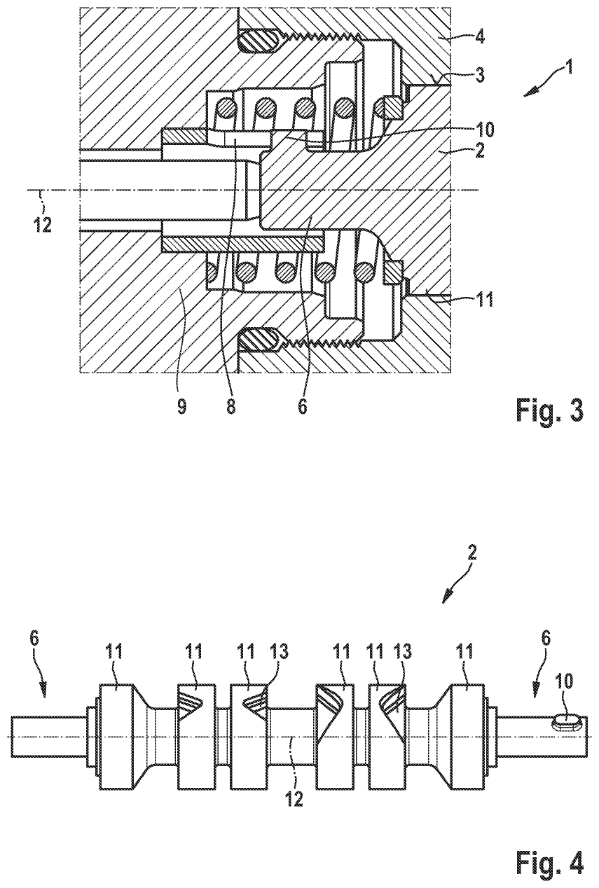

FIG. 3 shows a longitudinal section through a hydraulic valve 1 with a control slider 2 according to the present disclosure. The hydraulic valve 1 comprises the valve housing or the valve block 4 with the housing bore 3. The control slider 2 is movably mounted in the housing bore 3 of the valve housing 4. The valve housing 4 or the housing bore 3 accommodates the pole tube 9, which limits the axial movement of the control slider 2. The end portion 6 of the control slider 1 is movably accommodated in the pole tube 9. For this purpose, the pole tube 9 has an elongated guide groove or a guide sleeve 8, which extends in the longitudinal direction of the control cylinder 2. An anti-rotation lock of the control slider 2 is accommodated in the guide groove 8. The anti-rotation lock is a control slider integral lug 10 that protrudes radially from the end portion 6 of the control slider 2. The width of the control slider integral lug 10 is adapted to the width of the guide groove 8, such that the lug 10 is axially movably accommodated in the guide groove 8, but rotation of the control slider 2 about a longitudinal axis 12 of the control slider 2 relative to the guide groove 8 is prevented by the lug 10.

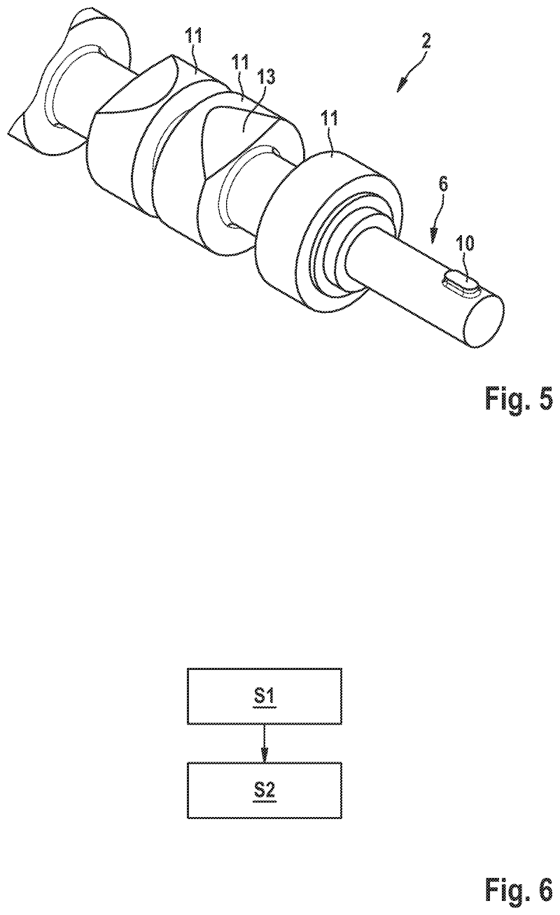

FIG. 4 shows a perspective view of the control slider 2. The control slider 2 comprises a middle portion and the two end portions 6. A number of control edges 11 are arranged next to one another in the middle portion. The control edges 11 each protrude radially from an outline of the control slider 2. The two end portions 6 are each arranged at an axial end of the middle portion, i.e., arranged outside the control edges 11. The control slider integral lug 10, which represents an anti-rotation lock, protrudes radially from an end portion. FIG. 5 shows a side view of the end portion 6 with the control slider integral lug 10.

The control edges 11 are not designed to be rotationally symmetrical, but can have control windows 13. The contour of the control edges 11 or the control windows 13 determines the control behavior of the hydraulic valve 1. As the recesses are not configured rotationally symmetrically, a rotation of the control slider 2 about its longitudinal axis 12 relative to the housing bore 3 could cause a change in the control behavior. Rotation of the control slider 2 about its longitudinal axis 12 results in abrasive wear on the contact surfaces between the control slider 2 and the housing bore 3, which leads to the control slider 2 becoming stuck in the housing bore 3 and thus to a functional failure of the hydraulic valve 1. Thus, the rotation of the control slider 2 about its longitudinal axis 12 is undesirable. The combination of the control slider integral lug 10 and the guide groove 8, in which the control slider integral lug 10 is accommodated, therefore represents an anti-rotation lock.

FIG. 6 shows a flow chart of a manufacturing process for the control slider 2. In step S1, the control slider 2 is machined from a raw material or blank. In the same step, the control slider integral lug 10 is also machined as an integral part of the control slider 2. The machining process is preferably milling or turning. In step S2, the machined control slider 2 is heat treated to realize a high surface hardness. Preferably, the step of heat treatment is hardening. Particularly preferably, the hardening is an induction hardening or an oven hardening. During induction hardening, a particular portion of the control slider 2 may be hardened. In particular, the control edges 11 are hardened. The control slider integral lug 10 is not hardened in this case in order to prevent embrittlement and thus a reduction of the toughness.

Step S1 can be divided into two sub-steps. A rough basic shape of the control slider can first be produced from the blank by turning. Then, the contours of the control edges 11 and the control slider integral lug 10 can be milled.

### LIST OF REFERENCE SIGNS

1 Hydraulic valve
2 Control slider
3 Housing bore
4 Valve body
5 Tensioning pin
6 End portion
7 Bore
8 Guide groove
9 Pole tube
10 Control slider integral lug
11 Control edges
12 Longitudinal axis
13 Control window

What is claimed is:

1. A hydraulic control slider arranged longitudinally displaceably in a housing bore of a hydraulic valve, the control slider comprising:
a middle portion having a number of control edges; and
two end portions each arranged on either side of the middle portion,
wherein one end portion of the two end portions comprises a radially outwardly protruding control slider integral lug.

2. The control slider according to claim 1, wherein the control slider integral lug is spaced apart from an end edge of the control slider.

3. The control slider according to claim 1, wherein the control slider integral lug extends in a longitudinal direction of the control slider.

4. The control slider according to claim 3, wherein the control slider integral lug is between 2 mm and 6 mm wide.

5. The control slider according to claim 1, wherein the control slider integral lug protrudes radially from the end portion between 1 mm and 3 mm.

6. A hydraulic valve comprising:
a valve housing defining a housing bore; and
a control slider movably mounted in the housing bore along a longitudinal axis,
wherein the control slider comprises an anti-rotation lock configured to protrude radially outward from the control slider
wherein the anti-rotation lock is accommodated in a guide groove of a pole tube mounted on the valve housing,
wherein the anti-rotation lock is configured to prevent rotation of the control slider about the longitudinal axis relative to the valve housing, and
wherein the anti-rotation lock is a control slider integral lug.

7. A manufacturing process for a control slider for a hydraulic valve, the process comprising:
machining the control slider from a raw material, including machining a control slider integral lug of the control slider as an integral part of the control slider; and
heat treating the machined control slider to harden the control slider.

8. The manufacturing process according to claim 7, wherein the machining comprises turning a control slider blank from the raw material, and milling control edges and the control slider integral lug from the turned control slider blank.

9. The manufacturing process according to claim 7, wherein the heat treating the control slider includes oven hardening the control slider.

10. The manufacturing process according to claim 8, wherein the heat treating the control slider includes induction hardening only the control edges of the control slider.
